(19) United States
(12) Patent Application Publication
(10) Pub. No.: US 2024/0283035 A1
(43) Pub. Date: Aug. 22, 2024

(54) SOLID-STATE BATTERY AND METHOD OF MANUFACTURING SOLID-STATE BATTERY

(71) Applicant: HONDA MOTOR CO., LTD., Tokyo (JP)

(72) Inventors: Takuya TANIUCHI, Saitama (JP); Terumi FURUTA, Saitama (JP)

(21) Appl. No.: 18/414,471

(22) Filed: Jan. 17, 2024

(30) Foreign Application Priority Data
Feb. 17, 2023 (JP) 2023-023120

(51) Int. Cl. H01M 10/42; H01M 4/02; H01M 4/134; H01M 4/38; H01M 50/46

(52) U.S. Cl. CPC H01M 10/4235; H01M 4/134; H01M 4/382; H01M 50/46; H01M 2004/027

(57) ABSTRACT

To provide a solid-state battery comprising an electrode laminate comprising a negative electrode current collector, a lithium metal layer, a solid electrolyte layer, a positive electrode material mixture layer, and a positive electrode current collector sequentially laminated, wherein one surface of the solid electrolyte layer faces the lithium metal layer, and an other surface faces the positive electrode material mixture layer; a resin or resin composition is disposed on outer periphery portions of the negative electrode current collector, the lithium metal layer, and the solid electrolyte layer of the electrode laminate; and a space formed between the lithium metal layer and the solid electrolyte layer formed by chemical conversion of the electrode laminate is filled with the resin or resin composition.

This application is based on and claims the benefit of priority from Japanese Patent Application No. 2023-023120, filed on 17 Feb. 2023, the content of which is incorporated herein by reference.

### BACKGROUND OF THE INVENTION

### Field of the Invention

The present invention relates to a solid-state battery and a method of manufacturing a solid-state battery.

### Related Art

In recent years, secondary batteries that contribute to energy efficiency have been researched and developed to ensure that more people have access to affordable, reliable, sustainable, and advanced energy.

Patent Document 1 describes a solid-state battery including a laminate including a current collector layer, an active material layer, and a solid electrolyte layer, a resin layer that covers at least a side surface of the laminate, and an exterior body that houses the laminate coated with the resin layer. Here, the resin layer includes at least a first resin layer and a second resin layer from the side surface of the laminate toward the exterior body, and the second resin layer is in contact with the exterior body. The second resin layer has a smaller Young's modulus than the first resin layer.
Patent Document 1: Japanese Unexamined Patent Application, Publication No. 2021-197204

### SUMMARY OF THE INVENTION

However, in the solid-state battery described in Patent Document 1, when a lithium metal layer is applied to a negative electrode active material layer, lithium metal is deposited during charging. Accordingly, by chemical conversion of the solid-state battery, a space is formed between the lithium metal layer and the surface of the solid electrolyte layer, not facing the positive electrode active material layer. As a result, in addition to a decrease in the strength of the solid-state battery, a lithium metal abnormally deposits, decreasing charge/discharge efficiency of the solid-state battery.

An object of the present invention is to provide a solid-state battery capable of improving strength and charge/discharge efficiency.

A first aspect of the present invention relates to a solid-state battery including an electrode laminate including a negative electrode current collector, a lithium metal layer, a solid electrolyte layer, a positive electrode material mixture layer, and a positive electrode current collector sequentially laminated, in which one surface of the solid electrolyte layer faces the lithium metal layer, and an other surface faces the positive electrode material mixture layer; a resin or resin composition is disposed on outer periphery portions of the negative electrode current collector, the lithium metal layer, and the solid electrolyte layer of the electrode laminate; and a space formed between the lithium metal layer and the solid electrolyte layer by chemical conversion of the electrode laminate is filled with the resin or resin composition.

A second aspect of the present invention relates to the solid-state battery as described in the first aspect, in which the electrode laminate includes a positive electrode insulating frame disposed on outer periphery portions of the positive electrode material mixture layer and the positive electrode current collector.

A third aspect of the present invention relates to the solid-state battery as described in the second aspect, in which the solid-state electrolyte layer has an incline portion, that inclines toward the positive electrode insulating frame side, formed in at least a part of a region facing the positive electrode insulating frame.

A fourth aspect of the present invention relates to the solid-state battery as described in any one of the first to third aspects, in which, in the electrode laminate, the positive electrode material mixture layer, the solid electrolyte layer, the lithium metal layer, and the negative electrode current collector are sequentially laminated on each of both surfaces of the positive electrode current collector, and a plurality of the electrode laminates are stacked.

A fifth aspect of the present invention relates to a method of manufacturing a solid-state battery including an electrode laminate including a negative electrode current collector, a lithium metal layer, a solid electrolyte layer, a positive electrode material mixture layer, and a positive electrode current collector sequentially laminated, with one surface of the solid electrolyte layer facing the lithium metal layer and an other surface facing the positive electrode material mixture layer, the method including disposing a resin or resin composition on outer periphery portions of the negative electrode current collector, the lithium metal layer, and the solid electrolyte layer of the electrode laminate, performing chemical conversion of the electrode laminate, and filling a space formed between the lithium metal layer and the solid electrolyte layer formed by the chemical conversion of the electrode laminate, with the resin or resin composition.

A sixth aspect of the present invention relates to the method of manufacturing a solid-state battery as described in the fifth aspect, in which the resin or resin composition is heated and/or pressurized when filling the space with the resin or resin composition.

A seventh aspect of the present invention relates to the method of manufacturing a solid-state battery as described in the fifth or sixth aspect, in which the resin or resin composition contains an ultraviolet ray curable resin, and after filling the space with the resin or resin composition, the resin or resin composition is irradiated with ultraviolet rays.

An eighth aspect of the present invention relates to the method of manufacturing a solid-state battery as described in any one of the fifth to seventh aspects, in which, in the electrode laminate, the positive electrode material mixture layer, the solid electrolyte layer, the lithium metal layer, and the negative electrode current collector are sequentially laminated on each of both surfaces of the positive electrode current collector; the method further includes stacking a plurality of the electrode laminates including the resin or resin composition disposed on the outer periphery portions, and performing chemical conversion of the plurality of electrode laminates.

According to the present invention, it is possible to provide a solid-state battery capable of improving strength and charge/discharge efficiency.

### BRIEF DESCRIPTION OF THE DRAWINGS

FIGS. 1A and 1B are cross-sectional views showing an example of the solid-state battery of the present embodiment;

FIG. 2 is a cross-sectional view showing a modified example of the solid-state battery of FIGS. 1A and 1B;

FIG. 3 is a cross-sectional view showing a modified example of the solid-state battery of FIGS. 1A and 1B;

FIGS. 4A and 4B are cross-sectional views showing a modified example of the solid-state battery of FIGS. 1A and 1B;

FIG. 5 is a cross-sectional view showing a method of manufacturing the solid-state battery of FIGS. 1A and 1B;

FIG. 6 is a cross-sectional view illustrating a method of manufacturing the solid-state battery of FIG. 2; and

FIG. 7 is a cross-sectional view illustrating a method of manufacturing the solid-state battery of FIG. 3.

### DETAILED DESCRIPTION OF THE INVENTION

Hereinafter, embodiments of the present invention will be described with reference to the accompanying drawings.

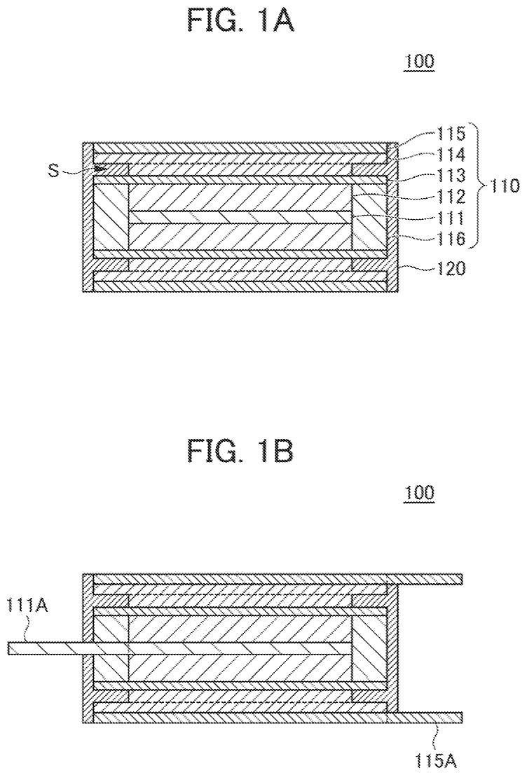

FIGS. 1A and 1B show an example of the solid-state battery of the present embodiment. Note that FIGS. 1A and 1B are cross sections perpendicular to and parallel to the direction in which the electrode tabs extend, respectively.

A solid-state battery 100 includes an electrode laminate 110 in which a positive electrode material mixture layer 112, a solid electrolyte layer 113, a lithium metal layer 114, and a negative electrode current collector 115 are sequentially laminated on each of both surfaces of a positive electrode current collector 111. Here, in the electrode laminate 110, a positive electrode insulating frame 116 is disposed on the outer periphery portions of the positive electrode current collector 111 and the positive electrode material mixture layer 112; and one surface of the solid electrolyte layer 113 faces the lithium metal layer 114, and the other surface faces the positive electrode material mixture layer 112 and the positive electrode insulating frame 116. In addition, in the solid battery 100, a resin or resin composition 120 is disposed on the outer periphery portions of the solid electrolyte layer 113, the lithium metal layer 114, the negative electrode current collector 115, and the positive electrode insulating frame 116 of the electrode laminate 110, and a space S formed between the solid electrolyte layer 113 and the lithium metal layer 114 by chemical conversion of the electrode laminate 110 is filled with the resin or resin composition 120. Therefore, in addition to improvement in the strength of the solid-state battery 100, abnormal deposition of lithium metal is suppressed, and charge/discharge efficiency of the solid-state battery 100 is improved.

At this time, in the solid-state battery 100, a positive electrode tab 111A extends from the positive electrode current collector 111, and a negative electrode tab 115A extends from the negative electrode current collector 115. The direction in which the positive electrode tab 111A extends is opposite to the direction in which the negative electrode tab 115A extends.

Note that, in the electrode laminate 110, the positive electrode insulating frame 116 may not be disposed on the outer periphery portions of the positive electrode current collector 111 and the positive electrode material mixture layer 112, and the other surface of the solid electrolyte layer 113 may face only the positive electrode material mixture layer 112. In this case, the positive electrode current collector 111 is disposed between the opposed positive electrode material mixture layers 112.

The positive electrode current collector 111 is not particularly limited, and examples thereof include aluminum foil.

The positive electrode material mixture layer 112 contains a positive electrode active material, and may further contain a solid electrolyte, a conductive auxiliary agent, a binder, and the like.

Examples of the positive electrode active material include, but are not limited to, LiCoO₂, Li(Ni_{5/10}Co_{2/10}Mn_{3/10})O₂, Li(Ni_{6/10}CO_{2/10}Mn_{2/10})O₂, Li(Ni_{8/10}Co_{1/10}Mn_{1/10})O₂, Li(Ni_{0.8}CO_{0.15}Al_{0.05} O₂, Li(Ni_{1/6}CO_{4/6}Mn_{1/6})O₂, Li(Ni_{1/3}CO_{1/3}Mn_{1/3})O₂, LiCoO₄, LiMn₂O₄, LiNiO₂, LiFePO₄, lithium sulfide, and sulfur as long as the positive electrode active material can occlude and release lithium ions.

The solid electrolyte constituting the solid electrolyte layer 113 is not particularly limited as long as it is a material capable of conducting lithium ions, and examples thereof include oxide-based electrolytes and sulfide-based electrolytes.

The negative electrode current collector 115 is not particularly limited, and examples thereof include copper foil.

A material constituting the positive electrode insulating frame 116 is not particularly limited as long as it has electron insulating properties, and examples thereof include insulating oxides such as alumina, resins such as polyvinylidene fluoride (PVDF), and rubbers such as styrene-butadiene rubber (SBR).

The positive electrode insulating frame 116 may have ion conductivity.

A resin or resin composition 120 is not particularly limited as long as it has electronic insulating properties, and examples thereof include resins, including thermoplastic resins such as polyvinylidene fluoride (PVDF), ultraviolet curable resins such as acrylic resins and epoxy resins, and rubber such as styrene-butadiene rubber (SBR), and resin compositions containing these resins. Examples of the resin compositions include fiber reinforced plastics.

The resin or resin composition 120 may have ion conductivity.

In this embodiment, the electrode laminate is not particularly limited as long as the negative electrode current collector, the lithium metal layer, the solid electrolyte layer, the positive electrode material mixture layer, and the positive electrode current collector are sequentially laminated in the electrode laminate. For example, in the electrode laminate 110, an intermediate layer having a function of uniformly depositing lithium metal may be formed between the solid electrolyte layer 113 and the lithium metal layer 114.

A material constituting the intermediate layer is not particularly limited, but examples thereof include carbon on which a metal capable of alloying with lithium is supported. The metal capable of alloying with lithium is not particularly limited, and examples thereof include silver.

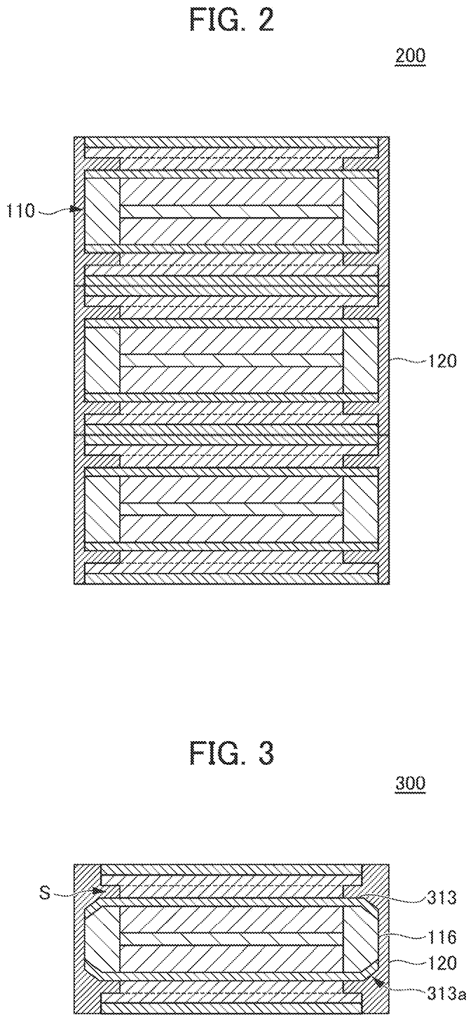

FIG. 2 shows a modified example of the solid-state battery 100.

A solid-state battery 200 is the same as the solid-state battery 100 except that a plurality of electrode laminates 110 are laminated.

Note that although the resin or resin composition 120 is disposed on the outer periphery portion of each electrode laminate 110, a resin or resin composition integrated on the outer periphery portions of the plurality of electrode laminates 110 may be disposed.

FIG. 3 shows a modified example of the solid-state battery 100.

A solid-state battery 300 is the same as the solid-state battery 100 except that a solid electrolyte layer 313 in which a planar incline portion 313a that inclines toward the positive electrode insulating frame 116 side is formed is disposed in a part of a region facing the positive electrode insulating frame 116, instead of the solid electrolyte layer 113. This facilitates filling the space S with the resin or resin composition 120.

In this embodiment, it is sufficient for the incline portion to be formed in at least a part of the region of the solid electrolyte layer facing the positive electrode insulating frame, and the incline portion may be formed in the entire region of the solid electrolyte layer facing the positive electrode insulating frame. The incline portion may be curved.

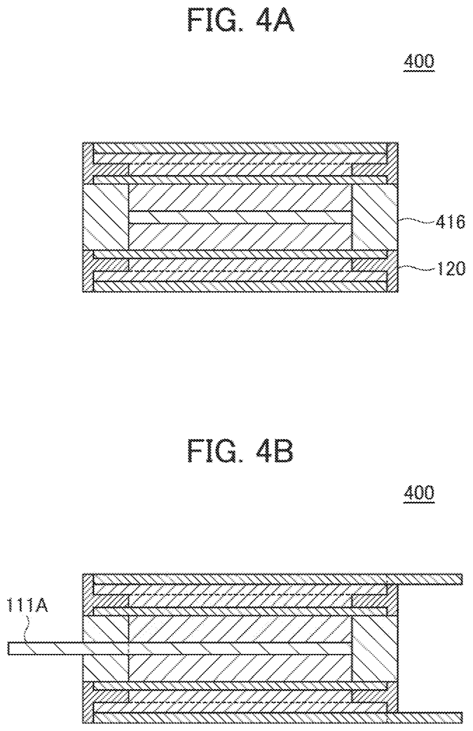

FIGS. 4A and 4B show a modified example of the solid-state battery 100.

A solid-state battery 400 is the same as the solid-state battery 100 except that a positive electrode insulating frame 416 in which the resin or resin composition 120 is not disposed is disposed in the outer periphery portions, instead of the positive electrode insulating frame 116 in which the resin or resin composition 120 is disposed in the outer periphery portions. In this case, the resin or resin composition 120 and the positive electrode insulating frame 416 constitute the outermost periphery of the solid-state battery 400. Further, the resin or resin composition 120 is not in contact with the positive electrode current collector 111 or the positive electrode tab 111A, and thus may have electron conductivity. Thereby, the resin or resin composition 120 functions as a heat transfer material, and thus, the cooling effect of the solid-state battery 400 is improved.

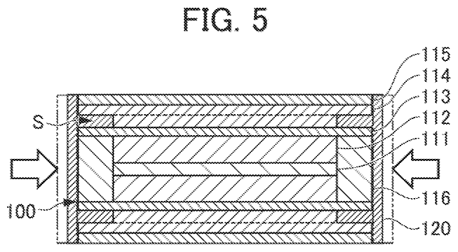

A method of manufacturing the solid-state battery 100 will be described with reference to FIG. 5.

First, after the resin or resin composition 120 is disposed on the outer periphery portion of the electrode laminate 110 (refer to the dash-dot-dot line in the drawing), chemical conversion of the electrode laminate 110 is performed. Next, the space S formed between the lithium metal layer 114 and the solid electrolyte layer 113 by chemical conversion of the electrode laminate 110 is filled with the resin or resin composition 120 (see a solid line in the drawing).

For example, when the resin or resin composition 120 contains a thermoplastic resin, the space S is filled with the resin or resin composition 120 by heating and/or pressurizing the resin or resin composition, and then the resin or resin composition is allowed to cool and cure. When the resin or resin composition 120 contains an ultraviolet ray curable resin, the space S is filled with the resin or resin composition 120 by heating and/or pressurizing the resin or resin composition, if necessary, and then the resin or resin composition is cured by irradiation with ultraviolet rays.

Timing of filling of the space S with the resin or resin composition 120 is not particularly limited as long as it is during the chemical conversion after formation of the space S. Since the volume of the space S is small, for example, when a charging rate is 0%, the space S is filled with the resin or resin composition 120. Here, when the resin or resin composition 120 is an elastomer (for example, rubber or a rubber composition), since the resin or resin composition 120 is elastically deformed, for example, when the charging rate is 100%, the space S may be filled with the resin or resin composition 120.

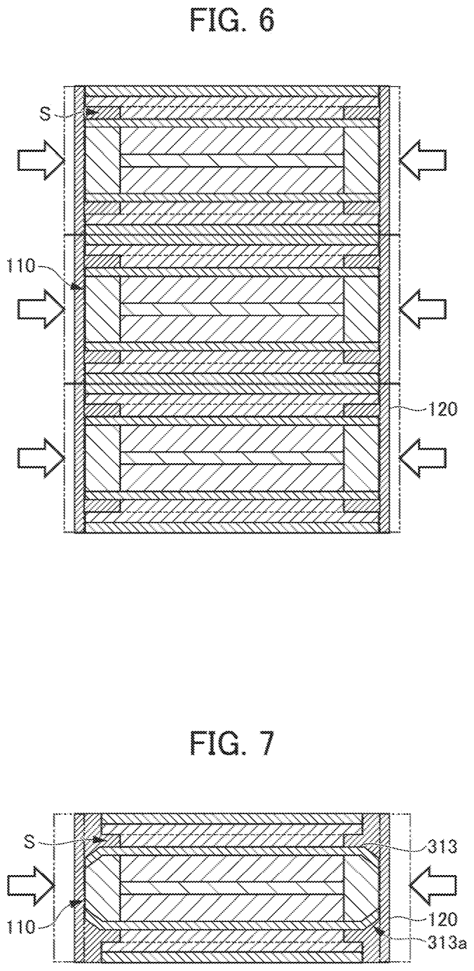

Next, a method of manufacturing the solid-state battery 200 will be described with reference to FIG. 6.

First, a plurality of electrode laminates 110 in which the resin or resin composition 120 is disposed on the outer periphery portions are laminated, and then chemical conversion of the plurality of laminated electrode laminates 110 is performed. Next, similarly to the solid-state battery 100, the space S is filled with the resin or resin composition 120.

Next, a method of manufacturing the solid-state battery 300 will be described with reference to FIG. 7.

First, similarly to the case of the solid-state battery 100, the electrode laminate 110 in which the resin or resin composition 120 is disposed in the outer periphery portions is subjected to chemical conversion, and then the space S is filled with the resin or resin composition 120. In this case, for example, if the space S is filled with the resin or resin composition 120 at a charging rate of 100%, since the incline portion 313a is formed in the solid electrolyte layer 313, the resin or resin composition 120 easily moves to the outside of the space S during discharge.

A method of manufacturing the solid-state battery 400 is the same as the method of manufacturing the solid-state battery 100 except that the resin or resin composition 120 is disposed on the outer periphery portion of the electrode laminate 110 at a distance corresponding to the positive electrode insulating frame 416.

Although the embodiments of the present invention have been described above, the present invention is not limited to the above-described embodiments, and the above-described embodiments may be appropriately modified within the scope of the present invention.

### EXPLANATION OF REFERENCE NUMERALS

100, 200, 300 and 400 Solid-state batteries
110 Electrode laminate
111 Positive electrode current collector
111A Positive electrode tab
112 Positive electrode material mixture layer
113 Solid electrolyte layer
114 Lithium metal layer
115 Negative electrode current collector
115A Negative electrode tab
116 Positive electrode insulating frame
120 Resin or resin composition
313 Solid electrolyte layer
313a Incline portion
416 Positive electrode insulating frame
S Space

What is claimed is:

1. A solid-state battery comprising an electrode laminate comprising a negative electrode current collector, a lithium metal layer, a solid electrolyte layer, a positive electrode material mixture layer, and a positive electrode current collector sequentially laminated,
wherein one surface of the solid electrolyte layer faces the lithium metal layer, and an other surface faces the positive electrode material mixture layer;
a resin or resin composition is disposed on outer periphery portions of the negative electrode current collector, the lithium metal layer, and the solid electrolyte layer of the electrode laminate; and a space formed between the lithium metal layer and the solid electrolyte layer formed by chemical conversion of the electrode laminate is filled with the resin or resin composition.

2. The solid-state battery according to claim 1, wherein the electrode laminate comprises a positive electrode insulating frame disposed on outer periphery portions of the positive electrode material mixture layer and the positive electrode current collector, and
the other surface of the solid electrolyte layer faces the positive electrode material mixture layer and the positive electrode insulating frame.

3. The solid-state battery according to claim 2, wherein the solid-state electrolyte layer has an incline portion, that inclines toward the positive electrode insulating frame side, formed in at least a part of a region facing the positive electrode insulating frame.

4. The solid-state battery according to claim 1, wherein, in the electrode laminate, the positive electrode material mixture layer, the solid electrolyte layer, the lithium metal layer, and the negative electrode current collector are sequentially laminated on each of both surfaces of the positive electrode current collector, and
a plurality of the electrode laminates are stacked.

5. A method of manufacturing a solid-state battery comprising an electrode laminate comprising a negative electrode current collector, a lithium metal layer, a solid electrolyte layer, a positive electrode material mixture layer, and a positive electrode current collector sequentially laminated,
with one surface of the solid electrolyte layer facing the lithium metal layer and an other surface facing the positive electrode material mixture layer,
the method comprising disposing a resin or resin composition on outer periphery portions of the negative electrode current collector, the lithium metal layer, and the solid electrolyte layer of the electrode laminate,
performing chemical conversion of the electrode laminate, and
filling a space formed between the lithium metal layer and the solid electrolyte layer formed by the chemical conversion of the electrode laminate, with the resin or resin composition.

6. The method of manufacturing a solid-state battery according to claim 5, the method comprising heating and/or pressurizing the resin or resin composition when filling the space with the resin or resin composition.

7. The method of manufacturing a solid-state battery according to claim 5,
wherein the resin or resin composition comprises an ultraviolet ray curable resin, and
after filling the space with the resin or resin composition, the resin or resin composition is irradiated with ultraviolet rays.

8. The method of manufacturing a solid-state battery according to claim 5,
wherein, in the electrode laminate, the positive electrode material mixture layer, the solid electrolyte layer, the lithium metal layer, and the negative electrode current collector are sequentially laminated on each of both surfaces of the positive electrode current collector;
the method further comprises stacking a plurality of the electrode laminates comprising the resin or resin composition disposed on the outer periphery portions, and
performing chemical conversion of the plurality of electrode laminates.
